(19) United States
(12) Patent Application Publication
(10) Pub. No.: US 2015/0258930 A1
(43) Pub. Date: Sep. 17, 2015

(54) DRIVING SUPPORT APPARATUS AND DRIVING SUPPORT SYSTEM

(71) Applicant: DENSO CORPORATION, Kariya-city, Aichi-pref. (JP)

(72) Inventor: Toshiaki Nakayama, Miyoshi-city (JP)

(21) Appl. No.: 14/433,876

(22) PCT Filed: Sep. 23, 2013
(86) PCT No.: PCT/JP2013/005603

§ 371 Date: Apr. 7, 2015

(30) Foreign Application Priority Data
Oct. 31, 2012 (JP) 2012-241298

(51) Int. Cl. B60Q 1/34; H04R 5/02; B60Q 9/00; H04R 17/00; H04S 1/00; H04R 5/04; H04R 5/033

(52) U.S. Cl. CPC B60Q 1/34; H04R 5/04; H04R 5/023; H04R 5/033; H04R 17/00; H04S 1/005; B60Q 9/00; H04R 2217/03

(57) ABSTRACT

A driving support apparatus that can provide only a driver with sound information useful for driving which facilitates the determination of right and left directions is provided. Upon operating a blinker to the right, the driving support apparatus turns on a right blinker, and also locates blinker operating sound in a right direction of a driver. Upon operating the blinker to the left, the driving support apparatus turns on a left blinker, and also locates the blinker operating sound in a left direction of the driver. Only the driver hears the blinker operating sound through a technique of a parametric speaker.

### CROSS REFERENCE TO RELATED APPLICATIONS

The present application is based on Japanese Patent Application No. 2012-241298 filed Oct. 31, 2012, the entire contents of which are incorporated herein by reference.

### TECHNICAL FIELD

The present disclosure relates to a driving support apparatus and a driving support system which perform driving support of a driver (vehicle driver).

### BACKGROUND ART

Techniques providing the driver with useful sound information for driving have been known. The useful sound information for driving includes, for example, blinker operating sound, warning sound indicating the presence of a pedestrian in a traveling direction of a vehicle, warning sound indicating the presence of another vehicle in a change-destination lane at the time of changing the lane, and warning sound indicating a possibility that the vehicle strays from a lane.

The sound information useful for driving is valuable for the driver, but may not be frequently required by other occupants or passengers.

For that reason, when useful sound information for driving is erased by a demand of a person other than the driver, the driver loses the useful sound information for driving.

A specific example will be described.

When operating the blinker, the driver hears blinker operating sound (relay sound of blinker called “ticktock”), thereby unconsciously or consciously preventing the on-operation of the blinker and the off-operation of the blinker from being forgotten.

However, occupants other than the driver may also feel bothered by blinker operating sound, and, for example, during the travel of a midnight bus, there is a demand to make the blinker operating sound inaudible to the passengers.

The blinker operating sound can be eliminated by measures to execute sound isolation of a blinker relay or mount the blinker relay at a remote location. However, the driver loses a sense of security to prevent the on-operation of the blinker and the off-operation of the blinker from being forgotten.

The useful sound information for driving (blinker operating sound, warning sound indicating the presence of a pedestrian in a traveling direction of the vehicle, warning sound indicating the presence of another vehicle in a change-destination lane at the time of changing the lane, and warning sound indicating the possibility of straying from the lane of the vehicle, for example) frequently has a distinction between right and left directions.

However, it is difficult for the driver to quickly determine the left or right direction on the basis of only sound information for monophonic (monaural).

Therefore, a proposed technique (not known art) localizes sound images on the right and left sides of the driver (stereo sound localization), and supports the driver in determining the accurate direction according to the localization directions of the sound.

However, visual information is prioritized over auditory information within a visual range of the front and the like. In other words, the visual information interferes with the auditory information. As a result, even when the sound images are localized on the right and left sides of the driver, it is difficult to accurately determine the direction of the sound image with the priority of the visual information.

### PRIOR ART LITERATURE

### Patent Literature

Patent Literature 1: JP-5-153687A

### SUMMARY OF INVENTION

The present disclosure has been made in view of the above circumstances. It is an object of the present disclosure to provide a driving support apparatus and a driving support system that provide “only a driver” with “sound information useful for driving” “which facilitates determination of right and left directions”.

According to a first example of the present disclosure, a driving support apparatus utilizes a stereophonic device and a visual display device. The stereophonic device stereoscopically locates a sound image with respect to a driver who drives a vehicle, with use of a right ear parametric speaker for emitting an ultrasonic wave toward a right ear of the driver to generate a reproduced sound in the right ear of the driver and a left ear parametric speaker for emitting the ultrasonic wave toward a left ear of the driver to generate the reproduced sound in the left ear of the driver. The visual display device uses a right visual display for performing visual display on a right side of the driver and a left visual display for performing visual display on a left side of the driver. When the stereophonic device is to locate the sound image on the right side of the driver, the right visual display of the visual display device performs the visual display on the right side of the driver. When the stereophonic device is to locate the sound image on the left side of the driver, the left visual display of the visual display device performs the visual display on the left side of the driver.

According to a second example of the present disclosure, a driving support system comprises a stereophonic device and a visual display device. The stereophonic device stereoscopically locates a sound image with respect to a driver who drives a vehicle, with the use of a right ear parametric speaker for emitting an ultrasonic wave toward a right ear of the driver to generate a reproduced sound in the right ear of the driver and a left ear parametric speaker for emitting the ultrasonic wave toward a left ear of the driver to generate the reproduced sound in the left ear of the driver. The visual display device includes a right visual display that performs visual display on a right side of the driver and a left visual display that performs visual display on a left side of the driver. When the stereophonic device is to locate the sound image on the right side of the driver, the right visual display of the visual display device performs the visual display on the right side of the driver. When the stereophonic device is to locate the sound image on the left side of the driver, the left visual display of the visual display device performs the visual display on the left side of the driver.

In the driving support apparatus and the driving support system according to the examples of the present disclosure, when the stereophonic device is to locate the sound image on the right side of the driver by the parametric speaker, the visual display device performs the visual display on the right side of the driver. That is, when the visual display device is to perform the visual display on the right side of the driver, the stereophonic device locates the sound image on the right side of the driver by the parametric speaker.

Likewise, in the driving support apparatus, when the stereophonic device is to locate the sound image on the left side of the driver by the parametric speaker, the visual display device performs the visual display on the left side of the driver. That is, when the visual display device is to perform the visual display on the left side of the driver, the stereophonic device locates the sound image on the left side of the driver by the parametric speaker.

Because a reproduced sound is generated in the right and left ears of the driver with use of the parametric speaker to stereoscopically locate the sound image, “only the driver” can obtain “the sound information useful for driving”. In this situation, an indicated direction of the visual display device is linked with a localization direction of the stereophonic device, thereby linking “the right and left directions of the auditory information” with “the right and left directions of the visual information” to “facilitate the determination of the right and left directions”.

That is, the driving support apparatus and the driving support system described above can provide “only the driver” with “sound information useful for driving” “which facilitates the determination of the right and left directions”.

### BRIEF DESCRIPTION OF DRAWINGS

The above-described and other objects, features, and advantages of the present disclosure will become more obvious through the specific description below with reference to the accompanying figures. In the drawings,

FIG. 1 is a diagram illustrating a driving support apparatus according to a first embodiment.

FIG. 2 is a diagram illustrating a recording equipment used for binaural recording according to the first embodiment.

FIG. 3 is a diagram illustrating a driving support apparatus according to a second embodiment.

FIG. 4 is a diagram illustrating a driving support apparatus according to a third embodiment.

FIG. 5 is a diagram illustrating a driving support apparatus according to a fourth embodiment.

### EMBODIMENTS FOR CARRYING OUT INVENTION

Hereinafter, embodiments of the present disclosure will be specifically described with reference to the drawings. The following embodiments show specific examples, and it is needless to say that embodiments of the present disclosure are not limited to the following examples.

### First Embodiment

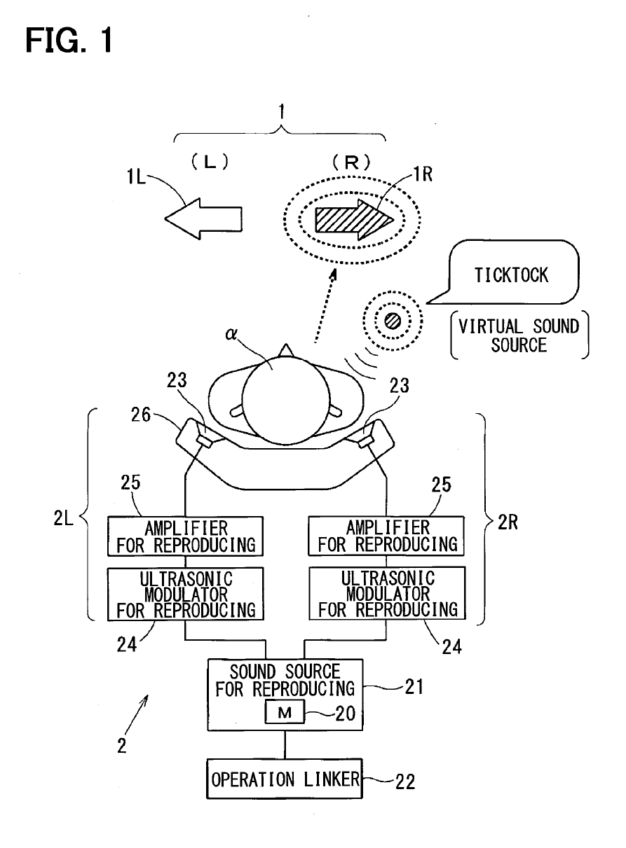

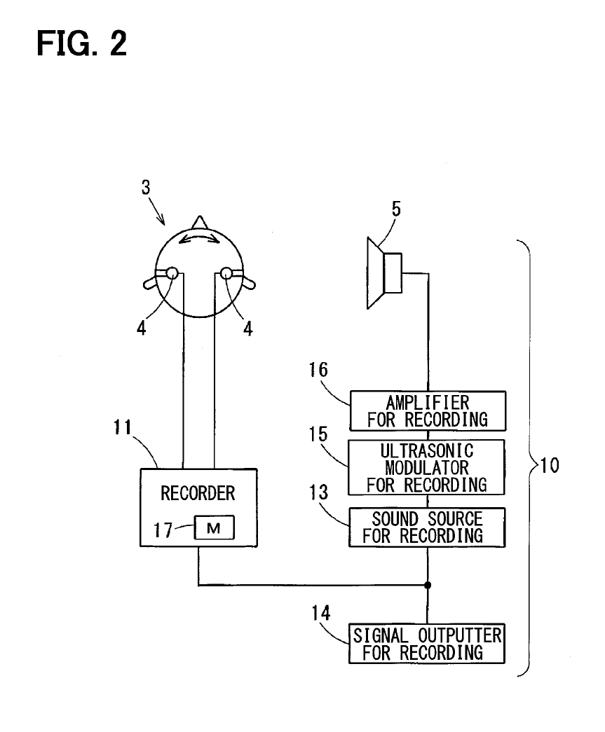

A first embodiment will be described with reference to FIGS. 1 and 2.

A driving support apparatus constituting a driving support system includes:

(i) a blinker device 1 that performs visual display in right and left directions of a driver α; and
(ii) a stereophonic device 2 that stereoscopically locates a sound image in the right and left directions of the driver α. The blinker device 1 corresponds to an example of a visual display device.

The blinker device 1 is a direction indicator always mounted on a vehicle and includes:

(i) a blinker lever that is operated in right and left directions by a driver α;

(ii) a right blinker 1R that is disposed on a right side of a steering wheel center in an instrument panel, and has a design of “right arrow”;

(iii) a left blinker 1L that is disposed on a left side of the steering wheel center in the instrument panel, and has a design of “left arrow”; and

(iv) an electric circuit part that turns on the right blinker 1R when the blinker lever is operated in the right direction, and turns on the left blinker 1L when the blinker lever is operated in the left direction. The right blinker 1R is an example of right visual display means and a right visual display. The left blinker 1L is an example of left visual display means and a left visual display date.

A blinker relay is provided so that the occupants such as the driver α or the other passengers do not directly hear relay operating sound (blinker operating sound). Specifically, the blinker relay is mounted at a position apart from a vehicle interior, or the blinker relay is covered with a sound insulation material or the like so that the occupants do not directly hear the relay operating sound.

The stereophonic device 2 includes:

(i) a right ear parametric speaker 2R that emits ultrasonic waves toward a right ear of the driver α to generate a reproduced sound in the right ear of the driver α; and

(ii) a left ear parametric speaker 2L that emits the ultrasonic waves toward a left ear of the driver α to generate the reproduced sound in the left ear of the driver α.

Specifically, the stereophonic device 2 according to the present embodiment allows only the driver α to hear the blinker operating sound, and

(i) locates the blinker operating sound in a right direction of the driver α when turning on the right blinker 1R, and

(ii) locates the blinker operating sound in a left direction of the driver α when turning on the left blinker 1L.

In this example, a sound source used in the stereophonic device 2 is produced with the use of binaural recording (but not limited).

As illustrated in FIG. 2, binaural recording is a two-channel sound recording that is recorded by using right and left microphones 4 arranged on right and left artificial ears of a dummy head 3 imitating a human head.

(Description of Binaural Recording)

The binaural recording in this embodiment is obtained by supplying ultrasonic modulated sound, which is obtained by modulating audible sound into supersonic waves, from a recording ultrasonic speaker 5 to the dummy head 3. A recording example will be described with reference to FIG. 2.

A recording sound wave generation device 10 and a recording device 11 are used for the binaural recording. The recording sound wave generation device 10 supplies the dummy head 3 with sound (blinker operating sound) used for recording. The sound used for recording is captured by the right and left microphones 4 of the dummy head 3 and is recorded by the recording device 11.

A preferred example of the dummy head 3 used in the binaural recording is that right and left pseudo ears are provided with pseudo pinnae (so-called earlobes) simulating outer ears of a person and pseudo ear canals (so-called ear holes), respectively, and right and left microphones 4 are placed in inner parts of the right and left pseudo ear canals, respectively.

(Description of Recording Sound Wave Generation Device 10)

The recording sound wave generation device 10 supplies “sound used for recording (blinker operating sound)” subjected to ultrasonic modulation to the dummy head 3 with the use of the parametric speakers. The recording sound wave generation device 10 includes:
the recording ultrasonic speaker 5 that generates ultrasonic waves in the parametric speaker,
a recording sound source unit 13 that can output a blinker operating sound signal,
a recording signal output unit 14 that outputs the blinker operating sound signal from the recording sound source unit 13,
a recording ultrasonic modulation unit 15 that modulates the blinker operating sound signal, which is output from the recording sound source unit 13, into a ultrasonic frequency, and
a recording amplifier 16 that drives the recording ultrasonic speaker 5. The blinker operating sound signal is an audio signal forming the blinker operating sound. The recording signal output unit 14 is an example of recording signal output means.

The recording ultrasonic speaker 5 is configured to generate air vibrations of higher frequencies (20 kHz or higher) than a human audible range. The recording ultrasonic speaker 5 includes, for example, plural piezoelectric elements for generating ultrasonic waves although not limited to this configuration.

The recording sound source unit 13 includes a personal computer with a memory or a program capable of generating the blinker operating sound signal.

The recording signal output unit 14 includes, for example, a controller such as a keyboard, and can output the blinker operating sound signal from the recording sound source unit 13.

The recording sound source unit 13 may pick up an actual operating sound of the blinker relay by a microphone.

The recording ultrasonic modulation unit 15 is configured to modulate the blinker operating sound signal, which is output by the recording sound source unit 13, into ultrasonic waves.

The recording amplifier 16 is configured to drive the recording ultrasonic speaker 5 on the basis of an ultrasonic signal modulated by the recording ultrasonic modulation unit 15, and includes, for example, a B class amplifier or a D class amplifier.

The ultrasonic waves are obtained by modulating the blinker operating sound signal, and are emitted from the recording ultrasonic speaker 5 toward the dummy head 3. As the ultrasonic waves propagate through the air, ultrasonic waves having short wavelength are distorted and dulled by the viscosity of the air or the like. Then, amplitude components included in the ultrasonic waves are self-demodulated during propagating in the air, and the blinker operating sound is reproduced in the dummy head 3.

That is, the blinker operating sound (reproduced sound) from the parametric speaker can be supplied to the dummy head 3.

(Description of Recording Device 11)

The recording device 11 includes a digital recording equipment (for example, personal computer) that stores in a memory 17 the binaural signals of two channels captured by the right and left microphones 4 on the dummy head 3. The recording device 11 stores the binaural signals of two channels captured by the respective right and left microphones 4 at separate addresses of the memory 17.

(Description of Recording Method)

The recording ultrasonic speaker 5 is installed to emit the ultrasonic waves toward a substantial center of the dummy head 3. Incidentally, it may be desirable that recording be performed in a place such as a silent room where there is little reverberation.

(a) In recording the blinker operating sound located on the right side of the driver α, the recording ultrasonic speaker 5 is arranged in the right direction of the dummy head 3 to perform recording, and records recorded sound in the memory 17. As a result, the binaural recording of the blinker operating sound located on the right side of the driver α is stored in the memory 17.

(b) In recording the blinker operating sound located on the left side of the driver α, the recording ultrasonic speaker 5 is arranged in the left direction of the dummy head 3 to perform recording, and records recorded sound in the memory 17. As a result, the binaural recording of the blinker operating sound located on the left side of the driver α is stored in the memory 17.

(Specific Description of Stereophonic Device 2)

The stereophonic device 2 includes:

(i) a reproduction sound source unit 21 including a memory 20 in which two types of right and left blinker operating sound signals (binaural recording) copied from the memory 17 are stored; and

(ii) the right ear parametric speaker 2R and the left ear parametric speaker 2L which reproduce the binaural recording recorded in the reproduction sound source unit 21 in the right and left ears of the driver α; and

(iii) an operation linking unit 22 that outputs the blinker operating sound signal from the reproduction sound source unit 21 in conjunction (link) with the operation of the blinker device 1. The operation linking unit 22 is an example of operation linking means.

The operation linking unit 22 is configured so that

(a) when the blinker lever is operated to the right side to turn on the right blinker 1R of the blinker device 1, the blinker operating sound signals (binaural recording) of two channels of the blinker operating sound located on the right side of the driver α are output from the reproduction sound source unit 21 to the right ear parametric speaker 2R and the left ear parametric speaker 2L, and

(b) when the blinker lever is operated to the left side to turn on the left blinker 1L of the blinker device 1, the blinker operating sound signals (binaural recording) of two channels of the blinker operating sound located on the left side of the driver α are output from the reproduction sound source unit 21 to the right ear parametric speaker 2R and the left ear parametric speaker 2L.

The right ear parametric speaker 2R and the left ear parametric speaker 2L supplies the blinker operating sound located on the right and the left to the driver α with the use of the parametric speaker of two channels. The right ear parametric speaker 2R and the left ear parametric speaker 2L include:
right and left reproduction ultrasonic speakers 23 that generate ultrasonic waves toward the right and left ears of the driver α, respectively,
reproduction ultrasonic modulation units 24 of two channels which modulate the blinker operating sound signals of two channels, which are output from the reproduction sound source unit 21, into ultrasonic frequencies, and
reproduction amplifiers 25 of two channels which drive the right and left reproduction ultrasonic speakers 23.

The right and left reproduction ultrasonic speakers 23 are configured to generate air vibrations at a frequency (20 kHz or higher) higher than a human audible range. The right and left reproduction ultrasonic speakers 23 may have the same basic configuration as the recording ultrasonic speaker 5, or may be ultrasonic speakers (for example, ribbon speaker, etc.) of a different type.

The right and left reproduction ultrasonic speakers 23 are configured to emit the ultrasonic waves toward the right and left ears of the driver α. As a specific installation example, FIG. 1 illustrates an example in which the right and left reproduction ultrasonic speakers 23 are installed in a vehicle seat 26 (head rest or an upper portion of a back rest).

The installation places of the right and left reproduction ultrasonic speakers 23 are not limited to the vehicle seat 25, but may be installed on other places such as a side of a meter panel (dashboard, etc.), pillars on both sides of a front glass, or a ceiling of the vehicle.

The reproduction ultrasonic modulation units 24 of two channels are configured to modulate the blinker operating sound signals of two channels output by the reproduction sound source unit 21 into the respective ultrasonic waves.

The reproduction amplifiers 25 of two channels are configured to drive the right and left reproduction ultrasonic speakers 23 on the basis of the ultrasonic signals modulated by the reproduction ultrasonic modulation units 24 of two channels. The reproduction amplifiers 25 include, for example, a B class amplifier or a D class amplifier.

The ultrasonic waves are obtained by modulating the blinker operating sound signal, and emitted toward the right and left ears of the driver α. As the ultrasonic waves propagate through the air, ultrasonic waves having short wavelength are distorted and dulled by the viscosity of the air or the like. Then, amplitude components included in the ultrasonic waves are self-demodulated during propagating in the air, and the blinker operating sound is reproduced in the right and left ears of the driver α. Alternatively, the ultrasonic waves that have reached a head of the driver α before demodulation are self-demodulated in the head (around the ears, etc.) of the driver α to reproduce the blinker operating sound in the right and left ears of the driver α.

A specific operation will be described below.

(a) When the occupant operates the blinker lever to the right side, the blinker device 1 turns on the right blinker 1R, and also the stereophonic device 2 locates the blinker operating sound on the right side of the driver α.

(b) When the occupant operates the blinker lever to the left side, the blinker device 1 turns on the left blinker 1R, and also the stereophonic device 2 locates the blinker operating sound on the left side of the driver α.

### First Advantage of Embodiment

Because the blinker operating sound is supplied to the ears of the driver α through the technique of the parametric speaker, only the driver α can obtain the blinker operating sound (an example of the sound information useful for driving). That is, the occupants other than the driver α have never feel the blinker operating sound cumbersome. For example, during the travel of a midnight bus, the blinker operating sound can be prevented from being heard by the passengers, and only the driver α can hear the blinker operating sound, there being capable of presenting the on-operation of the blinker and the off-operation of the blinker from being forgotten.

In this case, because the blinker operating sound is located in a direction corresponding to an indicating direction of the blinker device 1, the direction of the blinker can be unconsciously or consciously confirmed according to a location direction of the blinker operating sound. For that reason, a mistake to operate the blinker to an incorrect direction can be prevented, and a sense of security for the blinker operation can be enhanced.

That is, the driving support apparatus according to the first embodiment can provide “only the driver α” with “blinker operating sound (an example of sound information useful for driving)” “which facilitates the determination of the right and left directions”.

### Second Advantage of Embodiment

Because the blinker device 1 always mounted on the vehicle as a visual display unit is used, the costs for visual direction display can be suppressed. In other words, the present disclosure can be embodied with the suppression of the cost increase.

### Third Advantage of Embodiment

The blinker operating sound (an example of sound information useful for driving) is reproduced in the right and left ears of the driver α through the technique of the parametric speaker. Because the ultrasonic waves used for the parametric speaker have strong directivity, the recorded sound is exactly pinpoint-supplied to the right and left ears while the spread of the sound is suppressed. As a result, 3D information on the sound can be accurately reproduced for the driver α, and the blinker operating sound can be clearly localized on the right side or the left side of the driver α.

### Fourth Advantage of Embodiment

Because the reproduced sound is reproduced directly in the right and left ears of the driver α, the reproduced sound felt by the driver α becomes similar to a reproduced sound when wearing headphones. Under the circumstances, the binaural recording (recording technique of obtaining natural stereophony in the headphone reproduction) is used as a sound source used in the stereophonic device 2. This makes it possible to suppress the discomfort of the reproduced sound, and enhance the localization of the sound image.

### Fifth Advantage of Embodiment

The binaural recording used in the present embodiment is performed with the use of a reproduced sound from a parametric speaker.

Because the ultrasonic waves used for the parametric speaker have strong directivity, the sound used for recording can be pinpoint-supplied to the dummy head 3 while the spread of the sound is suppressed. That is, 3D information (localization information) on high-precision sound can be supplied to the right and left microphones 4 of the dummy head 3.

As a result, as compared with existing binaural recording, the binaural recording (recorded sound) significantly high in the localization of a sound direction can be obtained, and the accurate stereoscopic localization of sound can be given the driver α.

### Second Embodiment

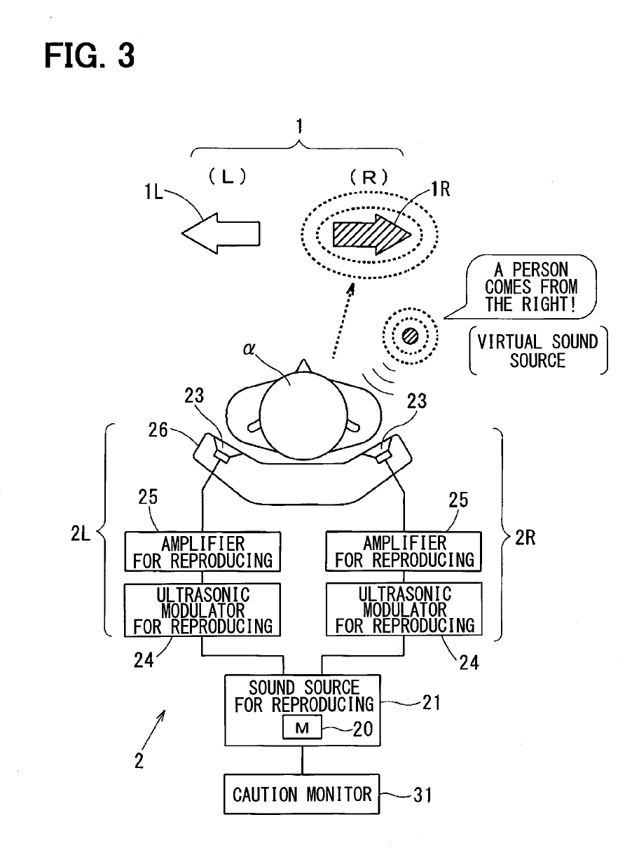

A second embodiment will be described with reference to FIG. 3. Like references are used to refer like functional parts between the above embodiment and the following embodiments.

The above first embodiment shows an example in which only the driver α hears the blinker operating sound at the time of operating the blinker.

On the contrary, the second embodiment is configured to supply warning sound (an example of sound information useful for driving) indicating the presence of a pedestrian in a traveling direction of a vehicle to only the driver α.

The driving support apparatus according to the second embodiment and the below-described third embodiment includes a caution monitoring unit 31 (an example of caution monitoring means) that determines in which direction of the vehicle a caution object occurs.

The driving support apparatus

(i) turns on the right blinker 1R by the blinker device 1, and localizes a warning sound on a right side of the driver α when the caution monitoring unit 31 detects the caution object in a right direction, and

(ii) turns on the left blinker 1L by the blinker device 1, and localizes the warning sound on a left side of the driver α when the caution monitoring unit 31 detects the caution object in a left direction.

Specifically, the caution monitoring unit 31 according to the second embodiment detects from which direction of the vehicle a pedestrian approaches.

The driving support apparatus

(i) localizes the warning sound (for example, sound such as “coming person from the right”) on the right side of the driver α by the stereophonic device 2, and executes the on-operation of the right blinker 1R by the blinker device 1 when the caution monitoring unit 31 detects that the pedestrian approaches from the right side of the vehicle, and

(ii) localizes the warning sound (for example, sound such as “coming person from the left”) on the left side of the driver α by the stereophonic device 2, and executes the on-operation of the left blinker 1L by the blinker device 1 when the caution monitoring unit 31 detects that the pedestrian approaches from the left side of the vehicle.

### Advantages of Second Embodiment

With this configuration, the warning sound which facilitates the determination of right and left directions (an example of useful sound information to the driver) can be provided to only the driver α.

Specifically, with the localization of the sound image of the warning sound on the right and left of the driver α or the like, support for determining an occurrence direction of the caution object can be implemented by the directivity of locating the sound. Also, the determination of the occurrence direction of the caution object can be compensated by a blinking direction of the caution object even if the occurrence direction of the caution object falls within a visual range such as the front where visual information is prioritized over auditory information. That is, the occurrence direction of the caution object within the visual range in front of the driver α can be easily and accurately determined by the driver α.

### Third Embodiment

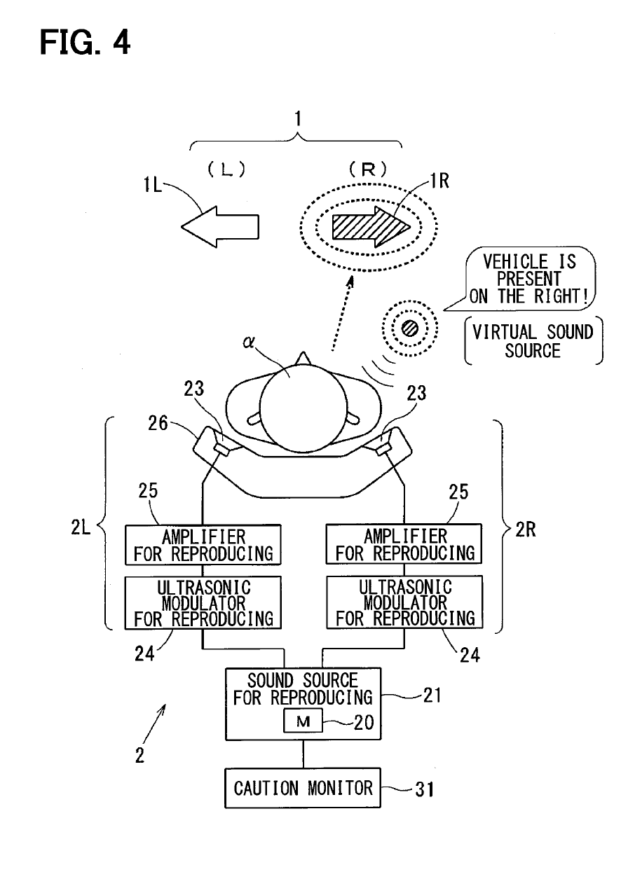

A third embodiment will be described with reference to FIG. 4.

A driving support apparatus according to the third embodiment includes the caution monitoring unit 31 that detects whether a vehicle is present in a change-destination lane (for example, right lane or left lane), or not, at the time of changing the lane (for example, at the time of operating a blinker).

The driving support apparatus

(i) localizes the warning sound (for example, sound such as “there is a vehicle on the right side”) on the right side of the driver α by the stereophonic device 2, and executes the on-operation of the right blinker 1R by the blinker device 1 when detecting that another vehicle is present on the right side of the vehicle at the time of changing the lane, and

(ii) localizes the warning sound (for example, sound such as “there is a vehicle on the left side”) on the left side of the driver α by the stereophonic device 2, and executes the on-operation of the left blinker 1L by the blinker device 1 when detecting that another vehicle is present on the left side of the vehicle at the time of changing the lane.

Even with this configuration, the same advantages as those in the second embodiment can be obtained.

### Fourth Embodiment

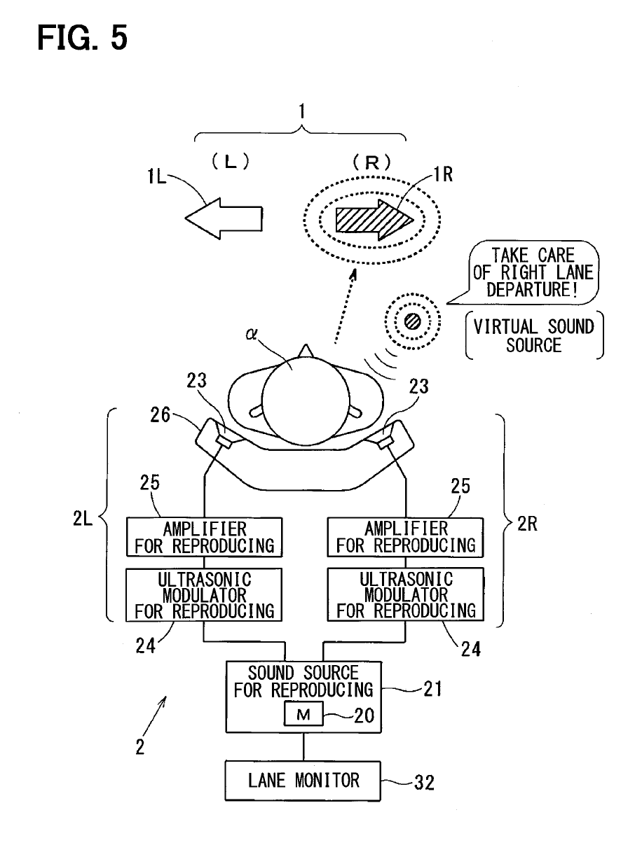

A fourth embodiment will be described with reference to FIG. 5.

A driving support apparatus according to the fourth embodiment includes a lane monitoring unit 32 (lane monitoring means) that detects that a possibility for the vehicle to stray from a driving lane has become higher.

The driving support apparatus

(i) locates a warning sound (for example, sound such as “be careful about right lane departure”, or sound effect) on a right side of the driver α by the stereophonic device 2, and executes the on-operation of the right blinker 1R by the blinker device 1 when the lane monitoring unit 32 detects the possibility that the vehicle strays in a right direction, and

(ii) locates the warning sound (for example, sound such as “be careful about left lane departure”, or sound effect) on a left side of the driver α by the stereophonic device 2, and executes the on-operation of the left blinker 1L by the blinker device 1 when the lane monitoring unit 32 detects the possibility that the vehicle strays in a left direction.

Even with the above arrangement, the same advantages as those in the second embodiment can be obtained.

Also, because persons other than the driver α do not hear the warning sound, there is no trouble that occupants are made anxious by trivial warning sound (unimportant warning sound).

The above embodiment shows an example in which the blinker device 1 is diverted as the visual display device. Alternatively, another visual display unit such as a window display (corresponding to an example of the visual display means) may be used.

In the above embodiments, a case in which the location direction of sound is only “right side” and “left side” has been described, but is not limited to those directions, and the sound may be located in other directions (front, right front, right rear, rear, left rear, left front, etc.).

Also, because the outside of the visual range is excellent in the localization of sound, the visual display device (blinker device, etc.) may be disposed not to operate outside the visual range (for example, right rear, left rear).

Embodiments and configurations according to the present disclosure have been illustrated. However, embodiments and configurations according to the present disclosure are not limited to the respective embodiments and configurations illustrated above. Embodiments and configurations obtained by appropriately combining respective technical elements disclosed in different embodiments and configurations are also included in embodiments and configurations according to the present disclosure.

1. A driving support apparatus utilizing:
a stereophonic device that stereoscopically locates a sound image with respect to a driver who drives a vehicle, with use of a right ear parametric speaker for emitting an ultrasonic wave toward a right ear of the driver to generate a reproduced sound in the right ear of the driver and a left ear parametric speaker for emitting the ultrasonic wave toward a left ear of the driver to generate the reproduced sound in the left ear of the driver; and
a visual display device that uses a right visual display for performing visual display on a right side of the driver and a left visual display for performing visual display on a left side of the driver, wherein:
when the stereophonic device is to locate the sound image on the right side of the driver, the right visual display of the visual display device performs the visual display on the right side of the driver;
when the stereophonic device is to locate the sound image on the left side of the driver, the left visual display of the visual display device performs the visual display on the left side of the driver;
a sound source used in the stereophonic device is produced with use of binaural recording; and
the binaural recording is performed with use of a sound reproduced by a parametric speaker.

2-3. (canceled)

4. The driving support apparatus according to claim 1, wherein
the visual display device is a blinker device,
the right visual display is a right blinker of the blinker device, and
the left visual display is a left blinker of the blinker device.

5. The driving support apparatus according to claim 4, wherein
the stereophonic device locates blinker operating sound on the right side of the driver when the right blinker of the blinker device is turned on, and
the stereophonic device locates the blinker operating sound on the left side of the driver when the left blinker of the blinker device is turned on.

6. The driving support apparatus according to claim 4, comprising:
a caution monitoring unit that detects in which direction of the vehicle a caution object occurs, wherein
when the caution monitoring unit detects the caution object in the right direction, the right blinker of the blinker device is turned on and a warning sound is located on the right side of the driver, and
when the caution monitoring unit detects the caution object in the left direction, the left blinker of the blinker device is turned on and the warning sound is located on the left side of the driver.

7. The driving support apparatus according to claim 4, comprising:
a lane monitoring unit that detects that a possibility for the vehicle to stray from a driving lane has become higher, wherein
when the lane monitoring unit detects the possibility that the vehicle strays in the right direction, the right blinker of the blinker device is turned on and a warning sound is located on the right side of the driver, and
when the lane monitoring unit detects the possibility that the vehicle strays in the left direction, the left blinker of the blinker device is tuned on and the warning sound is located on the left side of the driver.

8. A driving support system comprising:
a stereophonic device that stereoscopically locates a sound image with respect to a driver who drives a vehicle, with the use of a right ear parametric speaker for emitting an ultrasonic wave toward a right ear of the driver to generate a reproduced sound in the right ear of the driver and a left ear parametric speaker for emitting the ultrasonic wave toward a left ear of the driver to generate the reproduced sound in the left ear of the driver; and
a visual display device including a right visual display that performs visual display on a right side of the driver and a left visual display that performs visual display on a left side of the driver, wherein:
when the stereophonic device is to locate the sound image on the right side of the driver, the right visual display of the visual display device performs the visual display on the right side of the driver; and
when the stereophonic device is to locate the sound image on the left side of the driver, the left visual display of the visual display device performs the visual display on the left side of the driver;
a sound source used in the stereophonic device is produced with use of binaural recording; and
the binaural recording is performed with use of a sound reproduced by a parametric speaker.

9.-10. (canceled)

11. The driving support system according to claim 8, wherein
the visual display device is a blinker device,
the right visual display is a right blinker of the blinker device, and
the left visual display is a left blinker of the blinker device.

12. The driving support system according to claim 11, wherein
the stereophonic device locates blinker operating sound on the right side of the driver when the right blinker of the blinker device is turned on, and
the stereophonic device locates the blinker operating sound on the left side of the driver when the left blinker of the blinker device is turned on.

13. The driving support system according to claim 11, further comprising:
a caution monitoring unit that detects in which direction of the vehicle a caution object occurs, wherein
when the caution monitoring unit detects the caution object in the right direction, the right blinker of the blinker device is turned on and a warning sound is located on the right side of the driver, and
when the caution monitoring unit detects the caution object in the left direction, the left blinker of the blinker device is turned on and the warning sound is located on the left side of the driver.

14. The driving support system according to claim 11, further comprising:
a lane monitoring unit that detects that a possibility for the vehicle to stray from a driving lane has become higher, wherein
when the lane monitoring unit detects the possibility that the vehicle strays in the right direction, the right blinker of the blinker device is turned on and a warning sound is located on the right side of the driver, and
when the lane monitoring unit detects the possibility that the vehicle strays in the left direction, the blinker device turns on the left blinker of the blinker device is turned on and the warning sound is located on the left side of the driver.
